(19) United States
(12) Patent Application Publication
(10) Pub. No.: US 2025/0083099 A1
(43) Pub. Date: Mar. 13, 2025

(54) System, method and apparatus for Development of a chemical battery for captured carbon dioxide

(71) Applicant: SeaVar LLC, San Clemente, CA (US)

(72) Inventors: Uday Singh, San Clemente, CA (US); Shreyas Chipalkatty, Wickham Bishops (GB)

(21) Appl. No.: 18/805,707

(22) Filed: Aug. 15, 2024

Related U.S. Application Data
(60) Provisional application No. 63/599,501, filed on Nov. 15, 2023.
(60) Provisional application No. 63/537,532, filed on Sep. 10, 2023.

(51) Int. Cl. B01D 53/62; B01D 53/78; B01D 53/96

(52) U.S. Cl. CPC B01D 53/62; B01D 53/78; B01D 53/96; B01D 2251/302; B01D 2251/304; B01D 2251/306; B01D 2251/402; B01D 2251/604; B01D 2257/504

(57) ABSTRACT

One embodiment of the the invention is a method to develop a chemical battery for captured carbon dioxide, comprising: utilizing a hydroxide compound in water to absorb carbon dioxide from industrial exhaust gas; resulting in a solution of carbonates and bicarbonates in water; dewatering the solution, leaving solid carbonates and bicarbonates and thermally decomposing the solid carbonates and bicarbonates to an oxide compound, releasing pure CO2 gas; hydrating the oxide compound with water, forming a hydroxide compound; and then repeating the top step indefinitely. The hydroxide compound could be any one of sodium hydroxide, potassium hydroxide, magnesium hydroxide, or lithium hydroxide; and the respective oxide compound could be any one of sodium oxide, potassium oxide, magnesium oxide, or lithium oxide.

### PRIORITY CLAIM

This application claims the benefit of U.S. patent application Ser. No. 63/537,532, entitled “Development of a chemical battery for captured carbon dioxide”.

The disclosure of the above patent application is incorporated by reference as part of the specification of this application.

### FIELD OF THE INVENTION

The present invention relates to Development of a chemical battery for captured carbon dioxide.

### BACKGROUND

The background description includes information that may be useful in understanding the present invention. It is not an admission that any of the information provided herein is prior art or relevant to the presently claimed invention, or that any publication specifically or implicitly referenced is prior art.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply. The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties Such as concentration, reaction conditions, and so forth, used to describe and claim certain embodiments of the invention are to be understood as being modified in some instances by the term “about.”

Accordingly, in some embodiments, the numerical parameters set forth in the written description and attached claims are approximations that can vary depending upon the desired properties sought to be obtained by a particular embodiment.

In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an and “the includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “Such as”) provided with respect to certain embodiments herein is intended merely to better illuminate the invention and does not pose a limitation on the scope of the invention otherwise claimed.

No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any Such inclusion or deletion occurs, the specification is herein deemed to contain the group as modified thus fulfilling the written description of all Markush groups used in the appended claims.

Capturing CO2 from different industrial sources is now a globally urgent issue. There is a key problem with capturing CO2 from numerous industrial sources in globally diverse locations. Once captured, the CO2 must be either sequestered under the seabed or similar locations to ensure the CO2 cannot be released into the atmosphere. If the CO2 cannot be sequestered, then the CO2 must be converted into usable products like fuels, or the CO2 will be lost.

The technology for sequestration of CO2 is very expensive. On the other hand, the technology for converting CO2 into usable products like fuels is not economical, and is still in its developmental phase. Furthermore, using either sequestration or conversion into products like fuels would create too much CO2 for the current supply chain to handle. As in, the current supply chain would not be able to bring those products to a location where they could be utilized at a reasonable market price.

One idea for changing the supply chain to accommodate transporting CO2 as a gas is to build new ships or other transport that are specifically designed to transport gas, however, this would likely cost hundreds of millions of dollars.

### SUMMARY

The present invention solves these issues, because the present invention includes a process to both capture CO2 from industrial sources at a low cost, and then store the CO2 as a solid until it is ready for further processing. Waste heat can be used to decompose liquid carbonates formed during CO2 capture into oxides. Oxides can be relatively stable solids. Upon hydration with water, an oxide is converted into a hydroxide. A hydroxide can then be re-used to capture additional CO2. Prior to the decomposition of liquid carbonates, liquid carbonate is dewatered to a dry solid cake. The dry solid cake can be stored for long periods of time, and can be transported around the world in a compact fashion, so as to not waste space or require entirely new ships for transport.

Waste heat can be used to decompose liquid sodium or other carbonates formed during CO2 capture into sodium oxide. Sodium oxide is a relatively stable solid. Upon hydration with water, the sodium oxide is converted into sodium hydroxide. Sodium hydroxide can then be re-used to capture additional CO2. Prior to the decomposition of liquid sodium or other carbonates, liquid sodium carbonate is dewatered to a dry solid cake. The best option to decompose is liquid sodium carbonate/bicarbonate.

In the event suitable waste heat is not available at a location where CO2 is captured, dry solid cake of sodium carbonate can be shipped to a selected geographical location where abundant waste heat is available. At that location, decomposition of the sodium carbonate releases CO2 for storage and use, and simultaneously produces the sodium oxide ready for hydration to re-usable sodium hydroxide.

If captured CO2 gas cannot be sequestered or otherwise used at the location of capture, then the capture CO2 must be shipped as a highly compressed gas to a location where it is in demand. Shipping of compressed CO2 by sea or on land is expensive, and the energy required for compression makes the compression uneconomical.

In contrast, the present invention decouples the CO2 capture step from the sequestration or use step, because the sodium carbonate containing the captured CO2 is very stable and can be stored indefinitely at the location of capture. Alternatively, the sodium carbonate containing the captured CO2 can be shipped as a dense solid at relatively low cost to a location where waste heat is available, and furthermore it can be shipped at any convenient time. Therefore, solids containing captured CO2 act as a chemical battery.

These solids could be transported around the world using the existing supply chain and ships or other large-scale transport. Therefore, there would be no need to design and build new ships specifically to transport gas. Thus, the consumer and businesses would save money by using existing infrastructure.

There is at present no alternative method of creating a chemical battery to transport CO2 in this condensed manner utilizing existing ships or other large-scale transport. Therefore, this invention would solve an unmet need by all consumers of CO2.

### BRIEF DESCRIPTION OF THE DRAWINGS

Many aspects of the present disclosure can be better understood with reference to the attached drawings. The components in the drawings are not necessarily drawn to scale, with emphasis instead being placed upon clearly illustrating the principles of the disclosure. Moreover, in the drawings, like reference numerals designate corresponding parts throughout several views.

FIG. 1 is a drawing of the present invention according to various embodiments of the present disclosure.

FIG. 2 is a drawing of the present invention according to various embodiments of the present disclosure.

FIG. 3 is a drawing of the present invention according to various embodiments of the present disclosure.

FIG. 4 is a drawing of the present invention according to various embodiments of the present disclosure.

FIG. 5 is a drawing of the present invention according to various embodiments of the present disclosure.

FIG. 6 is a drawing of the present invention according to various embodiments of the present disclosure.

### DETAILED DESCRIPTION

Various embodiments of the present disclosure relate to providing a development of a chemical battery for captured carbon dioxide. The following example refers to sodium hydroxide, but applies to any hydroxide.

In one embodiment of the present invention, there is a wet process wherein water is in a solution. The solution is evaporated and put through a centrifuge. There is no minimal quantity for the solution, and there is no optimal quantity for the solution. One result is a moist solid cake. Next, the moist solid cake is put into a thermal reactor at 1100 degrees Celsius. This is because in order to decompose sodium hydroxide, the thermal reactor must be at least 1100 degrees Celsius. At 1100 degrees Celsius, both sodium carbonate and sodium bicarbonate will also decompose. Heating in the thermal reactor breaks down the moist solid cake into sodium oxide and other gases. A container is utilized to store the sodium oxide. The sodium oxide is useful because sodium oxide can be hydrated with water to form sodium hydroxide. Sodium hydroxide can then be used upstream to capture CO2.

In another embodiment of the present invention, an initial device is an absorber that uses sodium hydroxide to capture CO2. Sodium hydroxide can be used to capture CO2. The product of a hydroxide and carbon dioxide is a carbonate and a bicarbonate with some remaining excess hydroxide. Then waste heat is utilized to decompose liquid sodium or other carbonates formed during CO2 capture into sodium oxide. A few specific examples are as follows:

Example 1: The product of sodium hydroxide and carbon dioxide is sodium carbonate and sodium bicarbonate with some remaining excess sodium hydroxide. Then waste heat is utilized to decompose liquid sodium or other carbonates formed during CO2 capture into sodium oxide.

Example 2: The product of potassium hydroxide and carbon dioxide is potassium carbonate and potassium bicarbonate with some remaining excess potassium hydroxide. Then waste heat is utilized to decompose liquid potassium or other carbonates formed during CO2 capture into potassium oxide.

Example 3: The product of magnesium hydroxide and carbon dioxide is magnesium carbonate and magnesium bicarbonate with some remaining excess magnesium hydroxide. Then waste heat is utilized to decompose liquid sodium or other carbonates formed during CO2 capture into magnesium oxide.

Example 4: The product of lithium hydroxide and carbon dioxide is lithium carbonate and lithium bicarbonate with some remaining excess lithium hydroxide. Then waste heat is utilized to decompose liquid lithium or other carbonates formed during CO2 capture into lithium oxide.

Sodium oxide, potassium oxide, magnesium oxide and lithium oxide are all relatively stable solids, which is advantageous because then it can be stored at low cost for long periods of time. The sodium oxide is then hydrated with water, and this converts the sodium oxide into sodium hydroxide. Sodium hydroxide can then be re-used to capture additional CO2. Prior to the decomposition of liquid sodium or other carbonates, liquid sodium carbonate is dewatered to a dry solid cake.

The dry solid cake can then be stored for long periods of time, and can be easily transported anywhere in the world with existing ships or other transport. In one example, dry solid cake is made in one part of the world, but waste heat is in another part of the world. The dry solid cake can be transported by ship or other parts of the supply chain to a location that has waste heat. Since the dry solid cake is solid, it is dense and takes up less volume than transporting a gas, and so saves money on transportation.

Initially, sodium hydroxide must be commercially procured. However, once the cycle starts, there will be no need to acquire more sodium hydroxide, because it will be regenerated through the process above.

Sodium oxide is the most efficient form for the solid cake. After that, potassium oxide would be the next most efficient form for solid cake. Two other less efficient forms for solid cake would be lithium oxide and magnesium oxide.

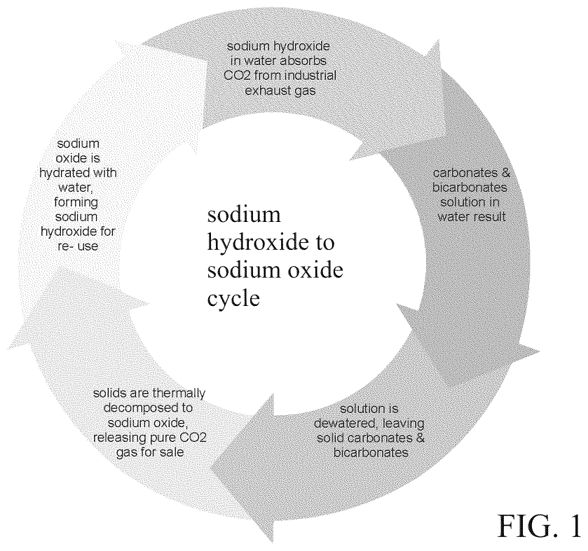

In FIG. 1, a sodium hydroxide to sodium oxide cycle is displayed, showing how sodium hydroxide in water absorbs CO2 from industrial exhaust gas. This results in a solution of carbonates and bicarbonates in water. Then the solution is dewatered, leaving solid carbonates and bicarbonates. Then the solid carbonates and bicarbonates are thermally decomposed to sodium oxide, releasing pure CO2 gas. This CO2 gas can be sold. Then, sodium oxide is hydrated with water, forming sodium hydroxide, and then the cycle can start again.

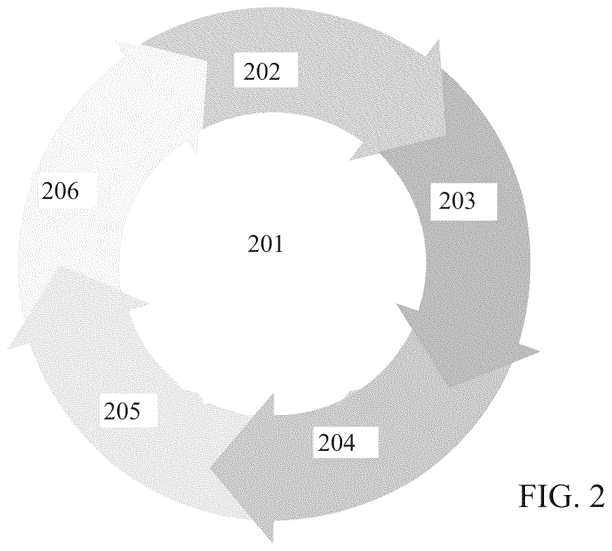

In FIG. 2, a sodium hydroxide to sodium oxide cycle 201 is displayed, showing step 202 in which sodium hydroxide in water absorbs CO2 from industrial exhaust gas. This results in step 203, which is a solution of carbonates and bicarbonates in water. Then step 204 is performed, in which the solution is dewatered, leaving solid carbonates and bicarbonates. Then step 205 is performed, in which the solid carbonates and bicarbonates are thermally decomposed to sodium oxide, releasing pure CO2 gas. This CO2 gas can be sold. Then in step 206, sodium oxide is hydrated with water, forming sodium hydroxide, and then the cycle can start again with step 202.

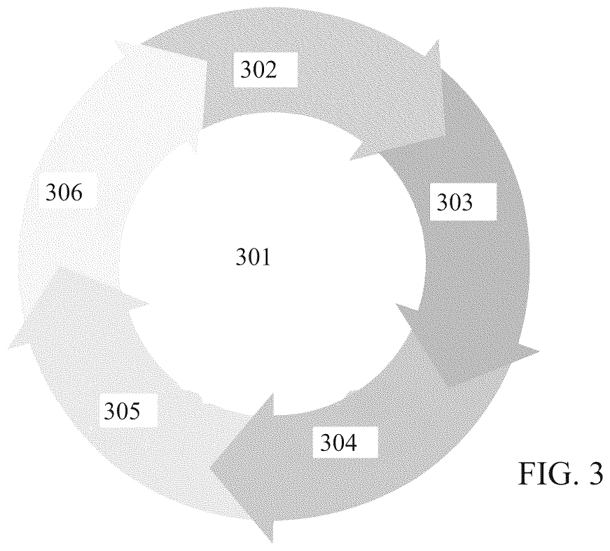

In FIG. 3, a potassium hydroxide to potassium oxide cycle 301 is displayed, showing step 302 in which potassium hydroxide in water absorbs CO2 from industrial exhaust gas. This results in step 303, which is a solution of carbonates and bicarbonates in water. Then step 304 is performed, in which the solution is dewatered, leaving solid carbonates and bicarbonates. Then step 305 is performed, in which the solid carbonates and bicarbonates are thermally decomposed to potassium oxide, releasing pure CO2 gas. This CO2 gas can be sold. Then in step 306, potassium oxide is hydrated with water, forming potassium hydroxide, and then the cycle can start again with step 302.

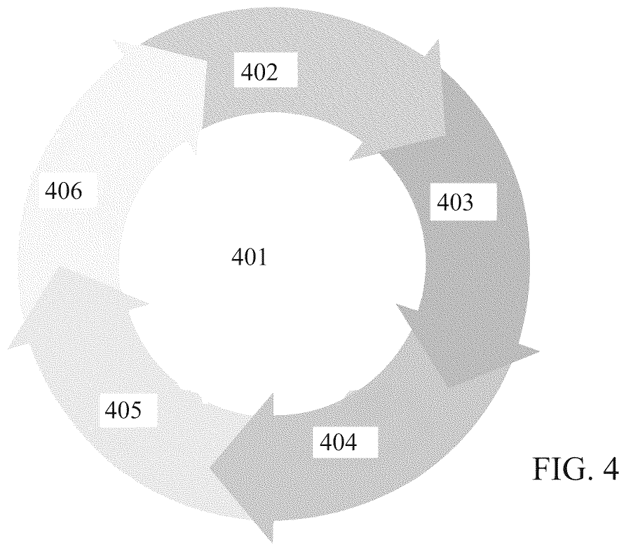

In FIG. 4, a lithium hydroxide to lithium oxide cycle 401 is displayed, showing step 402 in which lithium hydroxide in water absorbs CO2 from industrial exhaust gas. This results in step 403, which is a solution of carbonates and bicarbonates in water. Then step 404 is performed, in which the solution is dewatered, leaving solid carbonates and bicarbonates. Then step 405 is performed, in which the solid carbonates and bicarbonates are thermally decomposed to lithium oxide, releasing pure CO2 gas. This CO2 gas can be sold. Then in step 406, lithium oxide is hydrated with water, forming lithium hydroxide, and then the cycle can start again with step 402.

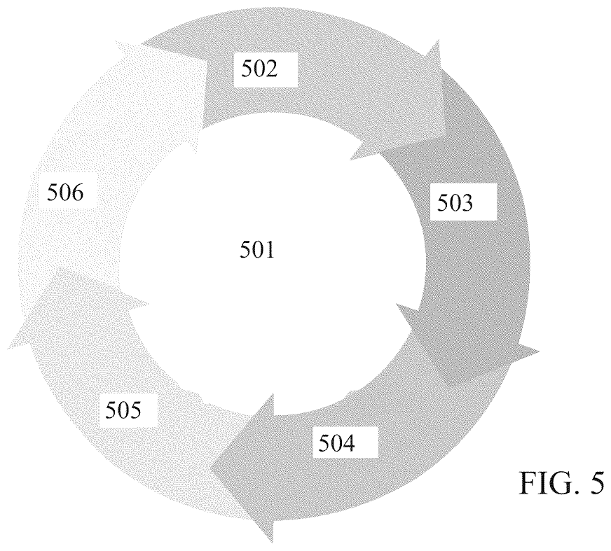

In FIG. 5, a magnesium hydroxide to magnesium oxide cycle 501 is displayed, showing step 502 in which magnesium hydroxide in water absorbs CO2 from industrial exhaust gas. This results in step 503, which is a solution of carbonates and bicarbonates in water. Then step 504 is performed, in which the solution is dewatered, leaving solid carbonates and bicarbonates. Then step 505 is performed, in which the solid carbonates and bicarbonates are thermally decomposed to magnesium oxide, releasing pure CO2 gas. This CO2 gas can be sold. Then in step 506, magnesium oxide is hydrated with water, forming magnesium hydroxide, and then the cycle can start again with step 502.

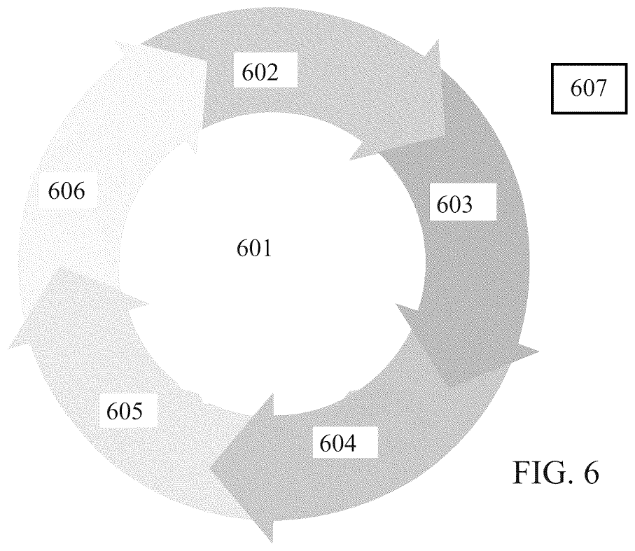

In FIG. 6, an element 607 hydroxide to an element 607 oxide cycle 601 is displayed, showing step 602 in which element 607 hydroxide in water absorbs CO2 from industrial exhaust gas. This results in step 603, which is a solution of carbonates and bicarbonates in water. Then step 604 is performed, in which the solution is dewatered, leaving solid carbonates and bicarbonates. Then step 605 is performed, in which the solid carbonates and bicarbonates are thermally decomposed to an element 607 oxide, releasing pure CO2 gas. This CO2 gas can be sold. Then in step 606, an element 607 oxide is hydrated with water, forming element 607 hydroxide, and then the cycle can start again with step 602.

In another embodiment of the present invention, the invention is a method to develop a chemical battery for captured carbon dioxide, comprising: utilizing a hydroxide compound in water to absorb carbon dioxide from industrial exhaust gas; resulting in a solution of carbonates and bicarbonates in water; dewatering the solution, leaving solid carbonates and bicarbonates thermally decomposing the solid carbonates and bicarbonates to an oxide compound, releasing pure CO2 gas; hydrating the oxide compound with water, forming a hydroxide compound; and then repeating the top step indefinitely.

In another embodiment of the present invention, the hydroxide compound is sodium hydroxide; and the oxide compound is sodium oxide.

In another embodiment of the present invention, the hydroxide compound is potassium hydroxide; and the oxide compound is potassium oxide.

In another embodiment of the present invention, the hydroxide compound is magnesium hydroxide; and the oxide compound is magnesium oxide.

In another embodiment of the present invention, the hydroxide compound is lithium hydroxide; and the oxide compound is lithium oxide.

In another embodiment of the present invention, the invention is a system to develop a chemical battery for captured carbon dioxide, comprising: utilizing a hydroxide compound in water to absorb carbon dioxide from industrial exhaust gas; resulting in a solution of carbonates and bicarbonates in water; dewatering the solution, leaving solid carbonates and bicarbonates thermally decomposing the solid carbonates and bicarbonates to an oxide compound, releasing pure CO2 gas; hydrating the oxide compound with water, forming a hydroxide compound; and then repeating the top step indefinitely.

In another embodiment of the present invention, the hydroxide compound is sodium hydroxide; and the oxide compound is sodium oxide.

In another embodiment of the present invention, the hydroxide compound is potassium hydroxide; and the oxide compound is potassium oxide.

In another embodiment of the present invention, the hydroxide compound is magnesium hydroxide; and the oxide compound is magnesium oxide.

In another embodiment of the present invention, the hydroxide compound is lithium hydroxide; and the oxide compound is lithium oxide.

In another embodiment of the present invention, the invention is an apparatus to develop a chemical battery for captured carbon dioxide, comprising: utilizing a hydroxide compound in water to absorb carbon dioxide from industrial exhaust gas; resulting in a solution of carbonates and bicarbonates in water; dewatering the solution, leaving solid carbonates and bicarbonates thermally decomposing the solid carbonates and bicarbonates to an oxide compound, releasing pure CO2 gas; hydrating the oxide compound with water, forming a hydroxide compound; and then repeating the top step indefinitely.

In another embodiment of the present invention, the hydroxide compound is sodium hydroxide; and the oxide compound is sodium oxide.

In another embodiment of the present invention, the hydroxide compound is potassium hydroxide; and the oxide compound is potassium oxide.

In another embodiment of the present invention, the hydroxide compound is magnesium hydroxide; and the oxide compound is magnesium oxide.

In another embodiment of the present invention, the hydroxide compound is lithium hydroxide; and the oxide compound is lithium oxide.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

1. A system to create a chemical battery for captured carbon dioxide, comprising:
utilizing any hydroxide compound in water to absorb carbon dioxide from industrial exhaust gas;
resulting in a solution of carbonates and bicarbonates in water;
dewatering the solution, leaving solid carbonates and bicarbonates;
storing the solid carbonates and bicarbonates for a time of up to 20 years;
wherein the solid carbonates and bicarbonates are transportable;
thermally decomposing the solid carbonates and bicarbonates to an oxide compound, releasing pure CO2 gas;
hydrating the oxide compound with water, forming a hydroxide compound;
and then repeating the top step indefinitely.

2. The system of claim 1, further comprising:
wherein the hydroxide compound is sodium hydroxide; and
wherein the oxide compound is sodium oxide.

3. The system of claim 1, further comprising:
wherein the hydroxide compound is potassium hydroxide; and
wherein the oxide compound is potassium oxide.

4. The system of claim 1, further comprising:
wherein the hydroxide compound is magnesium hydroxide; and
wherein the oxide compound is magnesium oxide.

5. The system of claim 1, further comprising:
wherein the hydroxide compound is lithium hydroxide; and
wherein the oxide compound is lithium oxide.

6. A method to develop a chemical battery for captured carbon dioxide, comprising:
utilizing any hydroxide compound in water to absorb carbon dioxide from industrial exhaust gas;
resulting in a solution of carbonates and bicarbonates in water;
dewatering the solution, leaving solid carbonates and bicarbonates;
storing the solid carbonates and bicarbonates for a time of up to 20 years;
wherein the solid carbonates and bicarbonates are transportable;
thermally decomposing the solid carbonates and bicarbonates to an oxide compound, releasing pure CO2 gas;
hydrating the oxide compound with water, forming a hydroxide compound;
and then repeating the top step indefinitely.

7. The method of claim 6, further comprising:
wherein the hydroxide compound is sodium hydroxide; and
wherein the oxide compound is sodium oxide.

8. The method of claim 6, further comprising:
wherein the hydroxide compound is potassium hydroxide; and
wherein the oxide compound is potassium oxide.

9. The method of claim 6, further comprising:
wherein the hydroxide compound is magnesium hydroxide; and
wherein the oxide compound is magnesium oxide.

10. The method of claim 6, further comprising:
wherein the hydroxide compound is lithium hydroxide; and
wherein the oxide compound is lithium oxide.

11. An apparatus to create a chemical battery for captured carbon dioxide, comprising:
utilizing any hydroxide compound in water to absorb carbon dioxide from industrial exhaust gas;
resulting in a solution of carbonates and bicarbonates in water;
dewatering the solution, leaving solid carbonates and bicarbonates;
storing the solid carbonates and bicarbonates for a time of up to 20 years;
wherein the solid carbonates and bicarbonates are transportable;
thermally decomposing the solid carbonates and bicarbonates to an oxide compound, releasing pure CO2 gas;
hydrating the oxide compound with water, forming a hydroxide compound;
and then repeating the top step indefinitely.

12. The apparatus of claim 11, further comprising:
wherein the hydroxide compound is sodium hydroxide; and
wherein the oxide compound is sodium oxide.

13. The apparatus of claim 11, further comprising:
wherein the hydroxide compound is potassium hydroxide; and
wherein the oxide compound is potassium oxide.

14. The apparatus of claim 11, further comprising:
wherein the hydroxide compound is magnesium hydroxide; and
wherein the oxide compound is magnesium oxide.

15. The apparatus of claim 11, further comprising:
wherein the hydroxide compound is lithium hydroxide; and
wherein the oxide compound is lithium oxide.
